(19) United States
(12) Patent Application Publication
(10) Pub. No.: US 2026/0001436 A1
(43) Pub. Date: Jan. 1, 2026

(54) AUTOMATED PUBLIC CHARGING FEATURE DETECTION SYSTEM

(71) Applicant: Ford Global Technologies, LLC, Dearborn, MI (US)

(72) Inventors: Kai Wu, Pittsburgh, PA (US); Venkatarao Rebba, Dearborn, MI (US); Dominique Meroux, Ann Arbor, MI (US); Prateek Bagga, Georgetown, TX (US); Chen Zhang, South Lyon, MI (US)

(21) Appl. No.: 18/757,847

(22) Filed: Jun. 28, 2024

(51) Int. Cl. B60L 53/66; B60L 53/30; B60L 53/68

(52) U.S. Cl. CPC B60L 53/66; B60L 53/305; B60L 53/68; B60L 2240/72

(57) ABSTRACT

A charger feature table is descriptive of which charging stations have which of a plurality of features. Vehicle data to capture according to each feature for each charging station, the vehicle data being specified in terms of types of sensors of vehicles of known configurations. A data request is broadcast to the vehicles indicating the vehicle data to be captured. New vehicle data is received from the vehicles responsive to the data request. A multi-modal model, trained to recognize the plurality of features using the types of sensors of the vehicles of known configurations, is used to determine an updated value for the feature based at least in part on the new vehicle data. The charger feature table is updated to include the updated value for the feature. The charger feature table is used to identify charging stations for a requesting vehicle.

### TECHNICAL FIELD

Aspects of the disclosure generally relate to an automated public charging feature detection system.

### BACKGROUND

The increased availability of electric vehicles has increased the amount of charging stations that are required for vehicles to use. Charging stations may have different attributes, such as charger plug type, maximum charge speed, charge to use, availability, reliability, and location.

### SUMMARY

In one or more illustrative examples, a method for using a multi-modal model to update a charger feature table includes: for each charging station indicated by a charger feature table descriptive of which charging stations have which of a plurality of features, and for each feature of the features of the charging station: if a value of the feature is unknown or stale: identifying vehicle data to capture according to the feature, the vehicle data being specified in terms of types of sensors of vehicles of known configurations; broadcasting a data request to the vehicles indicating the vehicle data to be captured; receiving new vehicle data from the vehicles responsive to the data request; using the multi-modal model, trained to recognize the plurality of features using the types of sensors of the vehicles of known configurations, to determine an updated value for the feature based at least in part on the new vehicle data; and updating the charger feature table to include the updated value for the feature; and using the charger feature table to identify charging stations for a requesting vehicle.

In one or more illustrative examples, a system for using a multi-modal model to update a charger feature table comprising: a charger monitoring server comprising one or more hardware processors configured to, for each charging station indicated by a charger feature table descriptive of which charging stations have which of a plurality of features, and for each feature of the features of the charging station: if a value of the feature is unknown or stale: identify vehicle data to capture according to the feature, the vehicle data being specified in terms of types of sensors of vehicles of known configurations, broadcast a data request to the vehicles indicating the vehicle data to be captured, receive new vehicle data from the vehicles responsive to the data request, use the multi-modal model, trained to recognize the plurality of features using the types of sensors of the vehicles of known configurations, to determine an updated value for the feature based at least in part on the new vehicle data, and update the charger feature table to include the updated value for the feature; and use the charger feature table to identify charging stations for a requesting vehicle.

In one or more illustrative examples, a non-transitory computer-readable medium comprising instructions for using a multi-modal model to update a charger feature table descriptive of which charging stations have which of a plurality of features that, when executed by one or more hardware processors of a charger monitoring server, cause the charger monitoring server to perform operations including to: for each charging station indicated by a charger feature table, and for each feature of the features of the charging station: if a value of the feature is unknown or stale: identify vehicle data to capture according to the feature, the vehicle data being specified in terms of types of sensors of vehicles of known configurations; broadcast a data request to the vehicles indicating the vehicle data to be captured; receive new vehicle data from the vehicles responsive to the data request; use the multi-modal model, trained to recognize the plurality of features using the types of sensors of the vehicles of known configurations, to determine an updated value for the feature based at least in part on the new vehicle data; and update the charger feature table to include the updated value for the feature; and use the charger feature table to identify charging stations for a requesting vehicle.

### BRIEF DESCRIPTION OF THE DRAWINGS

FIG. 1 illustrates an example system for machine-learned dynamic charging station assessment for vehicles;

FIG. 2 illustrates an example data flow of the operation of the multi-modal model for updating the charger feature table;

FIG. 3 illustrates an example process for the operation of the system in updating the charger feature table;

FIG. 4A illustrates an example of charging stations with a roof present;

FIG. 4B illustrates an example of charging stations without a roof present;

FIG. 5 illustrates an example semantic segmentation of vehicle data of an area surrounding a set of charging stations;

FIG. 6A illustrates an example of charging stations with perpendicular parking spots;

FIG. 6B illustrates an example of charging stations with parallel parking spots; and

FIG. 7 illustrates an example computing device for implementing machine-learned dynamic charging station assessment for vehicles.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As electric vehicles (EVs) become more popular, user experience at public charging stations has become more important. EV drivers may prefer a straightforward and efficient charging process, with an expectation of a successful connection on their first try. Given the potential waiting times for charging, access to accurate information about the best charging locations is essential.

Various aspects may be used by customers to define a quality charging experience. These aspects may include environmental aspects, such as the presence of nighttime illumination, cleanliness of a charging area, a rain roof over the chargers, cleanliness of the surroundings, and sufficient parking space size. These aspects may include amenities as well, such as availability of restrooms, café dining, number of chargers, and availability of grocery shops and/or retail shops. Static websites that rate charger features tend to fall out of date. Moreover, such websites may lack complete information.

Aspects of this disclosure relate to identifying and cataloging EV charging stations. The approach integrates vehicle sensor data with cloud computing by engaging a suite of sensors to capture data from both electric and non-electric vehicles, which is particularly effective when a vehicle is stationed at or in the vicinity of a charging facility. This approach utilizes vehicle sensors to collect data and transmits the gathered information, which may include signals, images, or videos, to a cloud system. For example, as an EV approaches a charging station and/or charges at a public charging station, or even as non-EVs park by or pass by EV chargers in a store parking lot at a usable visual angle, classifications may be performed of the EV charging stations, even though those vehicles making the measurements will not plug in themselves.

In addition, multimodal generative artificial intelligence (AI)-based algorithms may be employed to fuse the collected vehicle data with additional sources, such as customer feedback, visual content, and charging performance ratings, to create a comprehensive and continuously updated feature list for each charging location. This approach enhances the EV charging experience by providing manufacturers and users with valuable insights and contributing to the efficiency of the smart transportation ecosystem.

In some examples, the approach may identify infrastructure health status, such as cracks and potholes in pavement, signage damage or obstruction, structural issues with rooftops or canopies, lighting deficiencies, accessibility barriers, environmental hazards etc. These issues can be handled proactively via automatic maintenance requests to improve the overall working and functionality of the charging station.

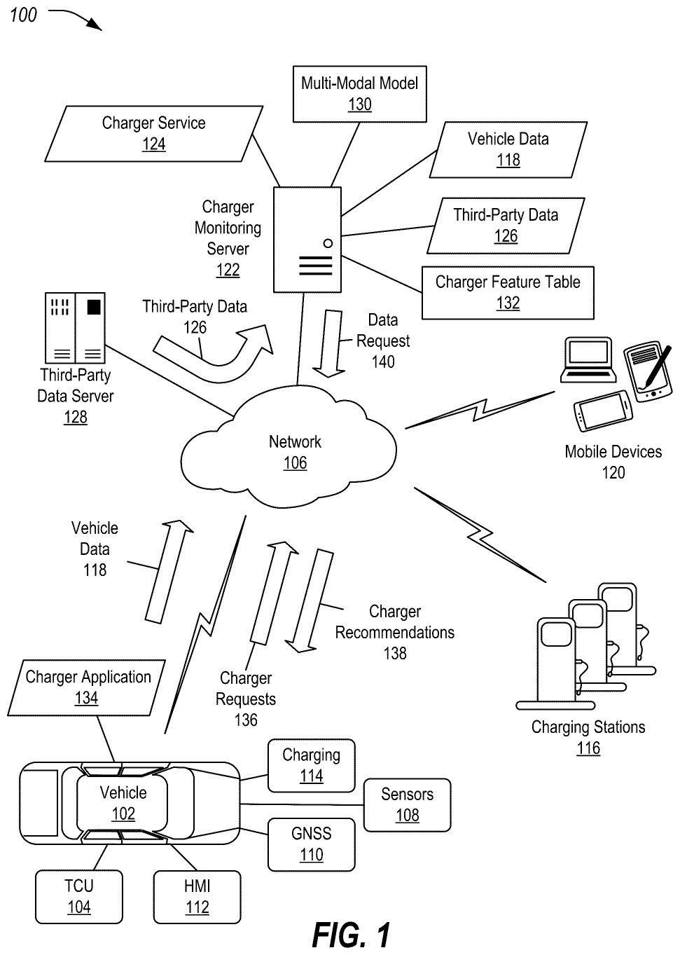

FIG. 1 illustrates an example system 100 for machine-learned dynamic charging station assessment for vehicles 102. The vehicle 102 includes components such as a telematics control unit (TCU) 104 configured to communicate over a communications network 106, sensors 108, a global navigation satellite system (GNSS) controller 110, and a human machine interface (HMI) controller 112. Optionally, if the vehicle 102 is an EV, the vehicle 102 may also include a charging controller 114 for communication with various charging stations 116. The vehicles 102, charging station 116, mobile devices 120, and a charger monitoring server 122 may be configured to communicate over the communications network 106. The charger monitoring server 122 may execute a charger service 124 and be configured to receive vehicle data 118 from the vehicles 102. The charger monitoring server 122 may also be configured to receive third-party data 126 from other sources, such as from a third-party data server 128. Using the vehicle data 118 and the third-party data 126, a multi-modal model 130 may be configured to update a charger feature table 132 descriptive of which charging stations 116 have which features. A charger application 134 may be installed to the vehicles 102. Using the charger application 134, the vehicle 102 may send a charger request 136 to the charger monitoring server 122. The charger service 124 may process the request to offer charger recommendations 138 based on the information in the charger feature table 132. The charger feature table 132 may accordingly be used to provide charger recommendations 138 to users of the vehicles 102. In some examples, there may be limited information available to the multi-modal model 130 to update the charger feature table 132. In such cases, the charger service 124 may send a data request 140 for additional vehicle data 118 and/or third-party data 126 to update the charger feature table 132. It should be noted that the system 100 is only one example implementation, and more, fewer, and/or different system 100 elements may be used.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be a battery electric vehicle (BEV) powered by a traction battery and one or more electric motors. As a further possibility, the vehicle 102 may be a hybrid electric vehicle powered by both an internal combustion engine, a traction battery, and one or more electric motors. Hybrid vehicles 102 may come in various forms, such as a series hybrid electric vehicle, a parallel hybrid electrical vehicle, or a parallel/series hybrid electric vehicle. As the type and configuration of vehicle 102 may vary, the capabilities of the vehicle 102 may correspondingly vary. As some possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs), globally unique identifiers (GUIDs), customer or fleet accounts, etc.

The vehicle 102 may include a plurality of components configured to perform and manage various vehicle 102 functions under the power of the vehicle battery and/or drivetrain. As depicted, the example vehicle components are represented as discrete controllers (e.g., the TCU 104, the sensors 108, the GNSS controller 110, the HMI controller 112, the charging controller 114, etc.). However, the components of the vehicle 102 may share physical hardware, firmware, and/or software, such that the functionality from multiple controllers may be integrated into a single controller, and that the functionality of various such controllers may be distributed across a plurality of controllers.

The TCU 104 may be utilized by the vehicle 102 for communication over the communications network 106. The TCU 104 may include network hardware configured to facilitate communication between the vehicle 102 and other devices of the system 100. For example, the TCU 104 may include or otherwise access a cellular modem configured to facilitate communication with the communications network 106. The communications network 106 may include one or more interconnected communication networks such as the Internet, a cable television distribution network, a satellite link network, a local area network, and a telephone network, as some non-limiting examples.

The sensors 108 may include various hardware of the vehicle 102 that is used to collect information about its surroundings and status. As some non-limiting examples, the sensors 108 may include one or more of cameras (e.g., advanced driver assistance system (ADAS) cameras), ultrasonic sensors, radio detection and ranging (RADAR) systems, and/or light detection and ranging (LIDAR) systems.

The GNSS controller 110 may be configured to provide information indicative of the current location of the vehicle 102. In an example, the GNSS controller 110 may be responsible for receiving signals from a GNSS constellation of satellites. This may allow the GNSS controller 110 to receive time information as well as for determining a precise location of the vehicle 102. The location determined by the GNSS controller 110 may be used for various tasks such as navigation or other location-based services.

The HMI controller 112 may be configured to provide an interface through which the vehicle 102 occupants may interact with the vehicle 102. The interface may include a touchscreen display, voice commands, and physical controls such as buttons and knobs. The HMI controller 112 may be configured to receive user input via the various buttons or other controls, as well as provide status information to a driver, such as fuel level information, engine operating temperature information, and current location of the vehicle 102. The HMI controller 112 may be configured to provide information to various displays within the vehicle 102, such as a center stack touchscreen, a gauge cluster screen, etc. The HMI controller 112 may accordingly allow the vehicle 102 occupants to access and control various systems such as navigation, entertainment, and climate control.

The charging controller 114 (included with those vehicles 102 that accept charging), may be configured to manage the charging of the battery, including monitoring the charging status, managing the flow of electricity, and communicating with the power grid. The charging controller 114 may be in communication with a port for connection to a charging station 116, using a cable or other device that allows the vehicle 102 to be charged from an external power source. The charging stations 116 may be configured to direct and manage the transfer of energy between a power source and the vehicle 102. An external power source may provide direct current (DC) or alternating current (AC) electric power to the charging stations 116. The charging stations 116 may, in turn, have a charge connector for plugging into a respective charge port of the vehicle 102. The charge port may be any type of port configured to transfer power from the charging stations 116 to the vehicle 102. Alternatively, the charging stations 116 may be configured to transfer power using other approaches, such as a wireless inductive coupling. However, the charging stations 116 are connected to the charging controller 114, the charging stations 116 may include circuitry and controls to direct and manage the transfer of energy between the power source and the vehicle 102.

The vehicle data 118 may include various information collected by the vehicle 102 using the sensors 108 and/or the charging controller 114. Regardless of whether the vehicle 102 is an EV, the vehicle data 118 may include images, sound, point clouds, etc., captured by the sensors 108 of the vehicle 102 when the vehicle 102 is within proximity to the charging stations 116.

For electric vehicles 102, the vehicle data 118 may further include information related to charging sessions performed by the vehicle 102. This may include, for example, status information transmitted between the vehicles 102 and the charging stations 116 and forwarded to the charger monitoring server 122 in various approaches. In an example, the vehicles 102 may send the vehicle data 118 responsive to occurrence of an event, such as a completed charge event, a charger plugged in event, etc. In another example, the vehicles 102 may send the vehicle data 118 to the charger services 124 periodically, or nightly, or at another time where network connectivity is available, such as when the vehicle 102 is at a home location and connected to a home network connected instead of to cellular.

The mobile device 120 may be any of various types of portable computing device, such as cellular phones, tablet computers, smart watches, laptop computers, portable music players, or other devices having processing and communications capabilities. The mobile device 120 may include one or more processors configured to execute computer instructions, and a storage medium on which the computer-executable instructions and/or data may be maintained.

The charger monitoring server 122 may be an example of a networked computing device that is accessible to the vehicles 102, mobile devices 120, charging stations 116, and/or other devices over the communications network 106. The charger monitoring server 122 may be configured to execute the charger service 124 to perform the operations of the charger monitoring server 122 discussed herein. The vehicle 102 may send data from its sensors 108 over the communications network 106 to the charger monitoring server 122. In the case of an EV, the vehicle 102 may monitor its charging station 116 usage and may send its vehicle data 118 over the communications network 106 to the charger monitoring server 122. In another EV example, the charger monitoring server 122 may be configured to receive vehicle data 118 from the charging stations 116 over the communications network 106 (e.g., as part of a billing process for charging station 116 usage or as a separate process).

In yet another example, based on the communication traffic in the network from vehicles 102 that share information at different times of day, month, season, etc., the charger monitoring server 122 may generate a distribution of querying status and/or congestion status for the charging stations 116. The information sharing may account for factors such as the type of vehicle 102, e.g., ICE, BEV, PHEV, etc., as different types may have different information sharing patterns due to aspects such as charging schedule. This information sharing may be used to determine the best times for receiving the vehicle data 118.

The third-party data 126 may refer to data from any of various sources in addition to the vehicle data 118 from the vehicles 102 and/or charging stations 116. This may include, as some non-limiting examples, user reviews of the charging stations 116, social media posts relating to the charging stations 116, web searches of the charging stations 116 and/or their surroundings, image searches of the charging stations 116 and/or their surroundings, etc. In some examples, the third-party data 126 may be received by the charger monitoring server 122 from one or more third-party data servers 128.

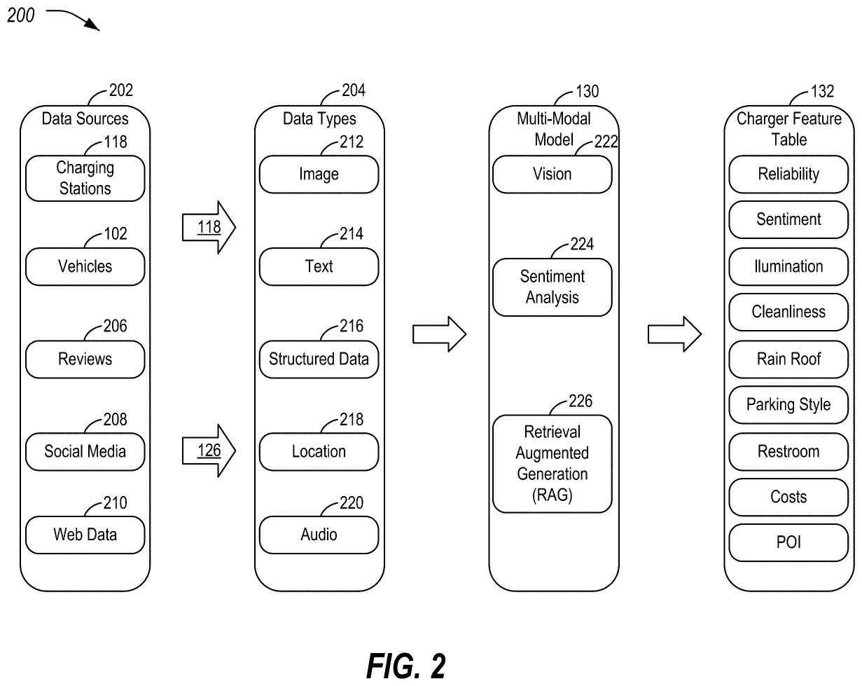

The charger monitoring server 122 may be configured to utilize a multi-modal model 130 to process the vehicle data 118. The multi-modal model 130 may be a machine learning (ML) model trained on information from multiple modalities, such as images, videos, text, and audio. In an example, to do so the multi-modal model 130 may process the disparate modalities of data together. Accordingly, the multi-modal model 130 may be able to process and find patterns in across the various modalities of data. The charger service 124 may be further configured to generate and/or update a charger feature table 132 based on the output of the multi-modal model 130. The charger feature table 132 may be descriptive of the features that are inferred for the various charging stations 116. Further aspects of the operation of the multi-modal model 130 are discussed with respect to FIG. 2.

A charger application 134 may be installed to the vehicle 102. Using the charger application 134, if the user has opted in, the vehicle 102 may send the vehicle data 118 to the charger service 124. Additionally, the user may send a charger request 136 to the charger service 124 to request that one or more charging stations 116 be recommended for charging the vehicle 102. The charger request 136 may include information such as the location of the vehicle 102 and an identifier of the user or of the vehicle 102. In response to receiving the charger request 136 from a vehicle 102, the charger service 124 may access the charger feature table 132 to provide charger recommendations 138 for the vehicle 102 requesting to be charged.

It should be noted that, in some cases, the charger service 124 may lack sufficient data about one or more of the charging stations 116. In such a case, the charger service 124 may request the vehicles 102 and/or the third-party data server 128 to collect additional data to be used by the multi-modal model 130 for updating the charger feature table 132. In an example, if the confidence that the multi-modal model 130 has in one or more aspects in the charger feature table 132, the charger service 124 may send a data request 140 that the vehicles 102 (whether EV or non) collect image or other data of the charging stations 116 to allow for a more accurate updating of the charger feature table 132. In another example, the charger service 124 may request input, e.g., photographs from users' mobile devices 120 as another form of data request 140 to collect image or other data of the charging stations 116 and/or their surroundings.

FIG. 2 illustrates an example data flow 200 of the operation of the multi-modal model 130 for updating the charger feature table 132. As shown, data sources 202 may include data of various data types 204, which are input to the multi-modal model 130. The multi-modal model 130 uses the inputs to infer information for addition to the charger feature table 132.

As noted herein, the data sources 202 may include the charging stations 116, the vehicles 102, and various third-party data servers 128. The information from the data sources 202 may include the vehicle data 118 and/or the third-party data 126 as noted above. In an example, the vehicle data 118 may include data from the sensors 108 of the vehicle 102. In another example, the vehicle data 118 may include data about charging sessions, which may be received from the charging stations 116 and/or from the vehicles 102. As some other examples, the third-party data 126 may include reviews 206 received from users of various charging stations 116 review services, social media 208 posts from various social media 208 sites, and/or web data 210 from various web

It should be noted that the contents of the vehicle data 118 and the third-party data 126 may include various data types 204. As shown, these data types 204 may include, as some examples, image data 212, textual data 214, structured data 216, geographical location data 218 such as GNSS locations, and/or audio data 220.

The image data 212 may include images, videos, point clouds, etc. captured by the sensors 108 of the vehicle 102. In another example, the image data 212 may include photos specifically requested from users' mobile devices. In another example, the image data 212 may include photos captured by users leaving reviews 206, images from social media 208, and/or images searches from web queries such as web and/or amenities surrounding the charging station. In yet another example, the image data 212 may include images taken by the charging station 116 facilities of their equipment and/or surroundings. In many examples, the image data 212 includes location metadata, which may be used to filter the images to those that correspond to the locations of the charging station 116 being analyzed.

The textual data 214 may include written information descriptive of the charging stations 116. The textual data 214 may be drafted by the owners or operators of the charging stations 116 in an example. In another example, the charging stations 116 may include text from users leaving reviews 206, posting to social media 208, and/or text from web queries relating to the charging stations 116 being analyzed.

The structured data 216 may include database data such as existing databases of charging station 116 information. For example, the structured data 216 may be made available by various third-party data servers 128 for analysis by downstream data consumers.

The geographical location data 218 may include GNSS data captured by the GNSS controller 110 of the vehicles 102. The geographical location data 218 may also include GNSS data included as metadata with the image data 212 and/or other types of data having embedded or otherwise associated location metadata or data.

The audio data 220 may include audio captured by microphones or other sensors 108 of the vehicle 102. In another example, the audio data 220 may include audio captured by users leaving audio reviews 206, posting audio to social media 208, audio clips from web data 210 searches etc.

The disparate data types 204 may be tokenized together as training material for the training of the multi-modal model 130. Additionally, the disparate data types 204 may be tokenized together as material for the determination of inferences about the charging stations 116. By using these different types of data together, a more complete view of the charging stations 116 may be modeled.

The multi-modal model 130 may utilize various techniques for the processing of the data sources 202 of the various data types 204. In an example, the multi-modal model 130 may make use of various computer vision 222 techniques, aspect-based sematic analysis 224, and/or retrieval augmented generation (RAG) 226 techniques.

The computer vision 222 may include various techniques for performing analysis of image data 212 by the multi-modal model 130. The techniques may include, for example, semantic segmentation to identify and classify objects in images or videos and to determine object boundaries. In another example, the techniques may include deep learning to identify image features to classify the image data 212 (e.g., illumination levels, and/or weather conditions). As another example, the techniques may include feature extraction to determine image shapes, colors, textures, etc., to convert the images into features for further processing. In still another example, captioning techniques may be used to apply text or other labeling to the identified features or segmentation, to facilitate further analysis of the data.

The semantic analysis 224 may include various techniques to determine sentiment from the vehicle data 118 and/or third-party data 126. In an example, a simple semantic analysis 224 may be performed to treat a text or other data element as a whole and assign it a single sentiment label (e.g., positive, negative, or neutral). In another example, aspect-based sentiment analysis (ABSA) may be performed to determine the sentiment with respect to a specific aspect (e.g., a feature of the charging station 116 for use in updating the charger feature table 132.

The RAG 226 may be used to improve the results of the multi-modal model 130 by relying on facts from various known-good data sources 202 and improving contextual understanding. The RAG 226 may be used to enlarge the dataset and/or features. For instance, the system 100 can directly build charging success rate and reliability from vehicles 102 and charging stations 116, and the RAG 226 can help extract those information elements into the charger feature table 132. For instance, RAG 226 may be useful in augmenting human-vetted charger feature table 132 information and/or other high-reliability data, thereby ensuring that additional inferences are tuned to that specific good data.

The result of the operation of the multi-modal model 130 is the charger feature table 132 data. The charger feature table 132 may include information with respect to the charging stations 116 such as reliability, sentiment, illumination, cleanliness, presence/absence of rain roofs, parking styles (e.g., parallel, periductular, etc.), presence/absence of restrooms, costs for charging, points of interest (POI) in proximity to the charging stations 116 (and in some cases ratings for those POIs in addition to indications of their presence), etc.

A sample portion of a charger feature table 132 is shown in Table 1:

TABLE 1
Sample Charger feature table

| | | | | | | |
|---|---|---|---|---|---|---|
| | | Cleanliness | | | | |
| Charging | Nighttime | of charging | Rain | Parking | | Snow |
| Location | illumination | area | roof | size/style | . . . | clearance |

| | | | | | |
|---|---|---|---|---|---|
| A | YES | YES | NO | UNKNOWN | YES |
| B | NO | NO | UNKNOWN | YES | NO |
| C | YES | NO | NO | YES | UNKNOWN |
| D | NO | NO | YES | UNKNOWN | UNKNOWN |

As shown in Table 1, each row of the charger feature table 132 may correspond to a specific charging station 116 and/or charging stations 116. For example, each row may include a charging location identifier identifying the specific charging station 116 and/or charging stations 116. While shown as A, B, C, D, this identifier may be a latitude, longitude, city, state, address, charging network etc.

In addition, each row may include information descriptive of the various charging location features. These features may include various environmental features that may be detected by the multi-modal model 130. As some non-limiting examples these features may include nighttime illumination, cleanliness of charging area, rain roof over charger, cleanliness of surrounding, parking space size, designated outside seating, etc.

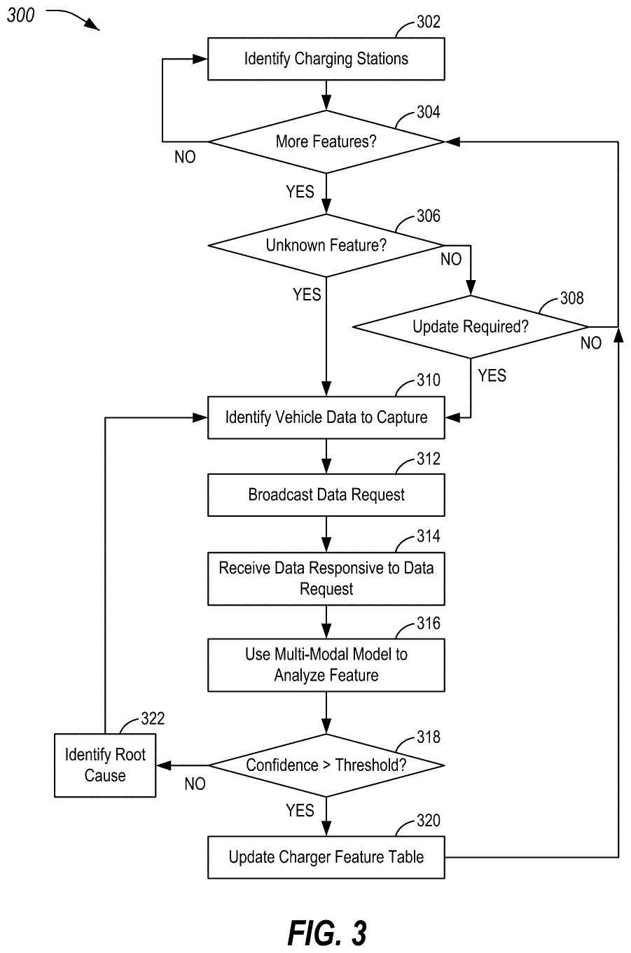

FIG. 3 illustrates an example process 300 for the operation of the system 100 in updating the charger feature table 132. In an example, the process 300 may be performed by the charger monitoring server 122 executing the charger service 124, in the context of the system 100.

At operation 302, the charger monitoring server 122 identifies a charging station 116 to analyze. In one example, the charger monitoring server 122 may iterate through the rows of the charger feature table 132. In another example, the charger monitoring server 122 may receive requests to add new charging station 116 and may perform the process 300 on those newly added charging stations 116.

At operation 304, the charger monitoring server 122 determines whether more features of the charging station 116 are to be analyzed. In an example, the charger monitoring server 122 may iterate through each column of the current row of the charger feature table 132 to determine which features to update. If more features are to be analyzed, control proceeds to operation 306. If all features have been analyzed and/or are up-to-date, control returns to operation 302 to analyze the next charging station 116.

At operation 306, the charger monitoring server 122 determines whether the feature of the charging station 116 is known or unknown in the charger feature table 132. In an example, the charger monitoring server 122 may determine whether the current row and column of the charger feature table 132 indicates that the value is known. If so, control passes to operation 308 to determine whether that known feature require an update. If not, then the feature is identified as being unknown, and control passes to operation 310.

At operation 308, the charger monitoring server 122 determines whether the known feature of the charging station 116 requires an update. For example, each of the feature may have a time-to-live value (e.g., one hour, one day, etc.) after which the feature is considered stale and needs to be updated. In some implementations this value is the same for each feature, but in other implementations this value varies by the feature, as some features (e.g., covered in snow) are more likely to change than other features (e.g., charging stations 116 with perpendicular vs parallel parking). If the feature has expired due to the time-to-live, control proceed to operation 310. If the feature is still considered valid, control returns to operation 304 to analyze the next feature.

In some examples, if new vehicle data 118 and/or third-party data 126 has been received related to a feature, then that feature may be considered stale due to the new data. In such a situation, control may pass to operation 310, even if the feature would otherwise still be considered known.

At operation 310, the charger monitoring server 122 identifies vehicle data 118 to capture. In an example, the charger monitoring server 122 may determine which vehicle data 118 to collect corresponding to the unknown feature. In another example, the charger monitoring server 122 may determine a sampling rate of the vehicle data 118 to be collected. For instance, some data may be collectable once to satisfy the request, while other data may require multiple samples over times to secure a reliable value. For instance, certain features may be best identified using image data 212 (such as presence or absence of a roof), while other feature may be best identified using video data over time (such as which locations tend to be in direct sun). Still other features, such as ambient noise level, may be best identified using audio data 220, etc.

At operation 312, the charger monitoring server 122 broadcasts a data request 140 for the vehicle data 118. This request may be sent in various ways. In one example, the data request 140 may be sent to all vehicles 102 (e.g., those having consented to respond to data requests 140). In another example, the data request 140 may be sent to vehicles 102 of a fleet. In yet another example, the data request 140 may be broadcast local to the charging station 116, to allow vehicles 102 in the vicinity of the charging station 116 to collect the information and reply.

At operation 314, the charger monitoring server 122 receives the vehicle data 118. In an example, the vehicles 102 having captured the requested data may send the data in a reply to the data request 140. In some examples, the data request 140 may include a response address for sending the data, e.g., the address of the charger monitoring server 122. In other examples, the data request 140 may be sent by the vehicles 102 to an address prestored by the vehicles 102 for replying to data requests 140. In some examples, the data may be sent by the vehicle 102 as it is collected and/or once is has been collected in accordance with the sampling rate of the vehicle data 118. In other examples, the data may be offloaded from the vehicle 102 at a later time, such as when the vehicle 102 is connected to WiFi, connected to Internet while charging, and/or connected at a home connection, to avoid adding congestion to the communications network 106 being used for moving vehicles 102.

At operation 316, the charger monitoring server 122 utilizes the multi-modal model 130 to analyze the feature of the charging station 116. In an example, the vehicle data 118 may be analyzed as discussed above with respect to the data flow 200 of FIG. 2. The result of the analysis may be an inferred value for the feature being analyzed.

At operation 318, the charger monitoring server 122 determines whether the result of the analysis has a confidence of at least a predefined threshold. In an example, the multi-modal model 130 may determine a confidence of the arrived at value in combination with the value. For instance, the multi-modal model 130 may provide a vector output of each possible value for the feature and a likelihood for each possible value. The most likely value above the predefined threshold may be inferred to be the value of the feature. If such a value is determined control passes to operation 320 to apply that value to the row and column of the charger feature table 132 being updated. After operation 302, control proceeds to operation 304 to process additional features and/or charging stations 116.

If, however, a value is not determined that exceeds the threshold, from operation 318 control proceeds to operation 322. At operation 322, the charger monitoring server 122 identifies a root case of the low confidence. For example, the received image data 212 may have been obstructed (e.g., by a truck in the way) such that the information that was intended to be collected was not actually collected. In some examples, the low confidence results may be flagged for human review to identify the root cause. Regardless, after operation 322, control passes to operation 310 to identify additional data to capture.

The process 300 may proceed to update all of the features of all of the charging stations 116. It should be noted that while the process 300 is shown as iterating on a single charging station 116 at a time, it should be noted that multiple charging stations 116 may be processed concurrently and/or one or more operations of the process 300 may be performed concurrently and/or in a different ordering than as shown. In addition, the operations performed in process 300 indicate the traffic occurred at multiple charging stations 116. This data, combined with the vehicle data 118, allows the charger monitoring server 122 to create a distribution of querying and congestion status for the charging stations 116 in the charger feature table 132.

For instance, batch processing may be used as a cost-effective approach to provide a higher degree of confidence in the results. Real-time data capture which involves analyzing live data as it comes in, which can be resource-intensive due to the need for high network bandwidth and computing power to manage the constant stream of information. In contrast, batch processing may utilize data collected over a specific period and process it in groups, which may allow for an efficient feature detection through the analysis of multiple data sets. However, the batch processing may require the charger monitoring server 122 to utilize additional storage for the maintenance of the data while being batched up for processing.

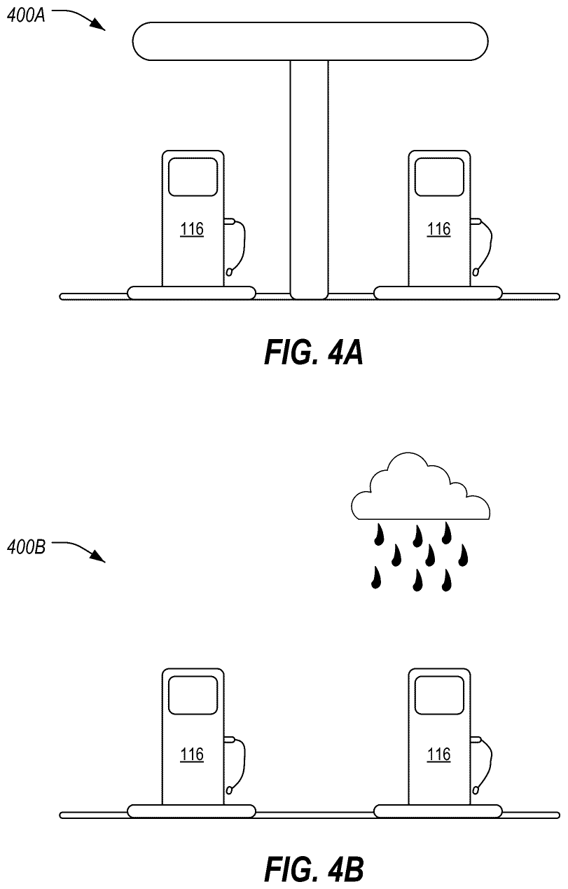

FIGS. 4A-4B collectively illustrate a specific example of the presence and absence of a roof above the charging stations 116. FIG. 4A illustrates an example 400A of charging stations 116 with a roof present, while FIG. 4B illustrates an example 400B of charging stations 116 without a roof present. In FIG. 4B, it is noted by the rain cloud that there may be less protection from the elements at the charging stations 116 showing in FIG. 4B as compared to in FIG. 4A.

To update the feature corresponding to the rain roof, the charger monitoring server 122 may request vehicle data 118 including ADAS frontend and surrounding camera sensors 108 as well as data from rain sensors 108 of the vehicle 102. This information may allow the model to both see and track moisture in the proximity of the charging stations 116 to make the determination of whether a roof is or is not present.

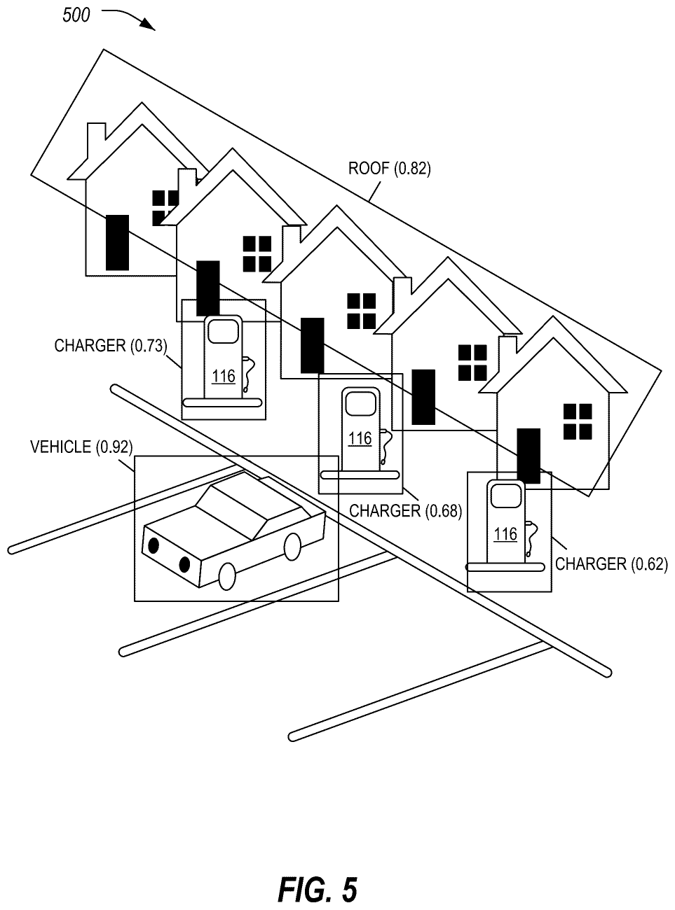

FIG. 5 illustrates an example semantic segmentation 500 of vehicle data 118 of an area surrounding a set of charging stations 116. As shown, the charging stations 116 are identified, as is a vehicle 102 in proximity of the charging stations 116. Additionally, roof is detected with high probability above the charging stations 116. However, in this instance, due to the perspective of the image, the multi-modal model 130 may incorrectly infer that these charging stations 116 have a covered roof, when in fact they do not and are instead in front of other buildings that have roofs.

Other misdetection variations are possible. For example, on a cloudy day, a gray sky may be incorrectly labeled by the multi-modal model 130 as being a roof when no roof is present. Or, if an image is taken from inside the vehicle 102 cabin, the rear view mirror in the resultant image may be misinterpreted by the multi-modal model 130 as being a roof as well.

To address these types of issues, the disclosed approach ensures that, because the data is collected form the vehicles 102, and because the configurations of the sensors 108 as built is predefined and known, the data collected by the vehicles 102 conforms to specific known height, field-of-view, depth of image, etc. characteristics to ensure more consistent captured data. For instance, the data request 140 from the charger monitoring server 122 may require the use of calibrated camera photos from the front grill camera sensor 108 and/or from the front windshield camera sensor 108 of the vehicle 102. In doing so, misdetection issues with crowd-sourced data taken from unusual angles and/or from inside the vehicle 102 cabin without ensuring that mirrors and other obstructions may be prevented.

Moreover, to ensure favorable weather conditions, the multi-modal model 130 of the charger monitoring server 122 may make use of rain sensors 108 or light sensors 108. Light sensors 108 may be situated on the instrument panel, the rearview mirror, or the exterior surface of the vehicle 102, enabling such sensors 108 to accurately gauge the ambient light intensity around the vehicle 102. These sensors 108 may employ various technologies to detect light and convert it into an electrical signal, which is then processed by the lighting control system of the vehicle 102. Similarly, rain sensors 108 may be placed in proximity to the front windshield, e.g., at or adjacent to the mounting of the rear-view mirror to avoid obstructing the windshield. These sensors 108 may be configured to detect a chance in capacitance, in an example, which may be used to infer the presence of rain.

Because the multi-modal model 130 can directly utilize multiple sensor data types 204, the system 100 may directly utilize rain sensors 108 and/or the light sensors 108 to confirm the presence of a rain roof. For instance, if the rain sensors 108 are activated, indicating that it is raining, and the windshield wipers have commenced operation, it can be inferred that the parking spot lacks an overhead rain roof, despite, e.g., the image data 212 being inconclusive for the location of the vehicle 102. In contrast, if the light sensors 108 indicate a bright condition, then this may be used as an addition data point to indicate there is not a roof at the location of the vehicle 102.

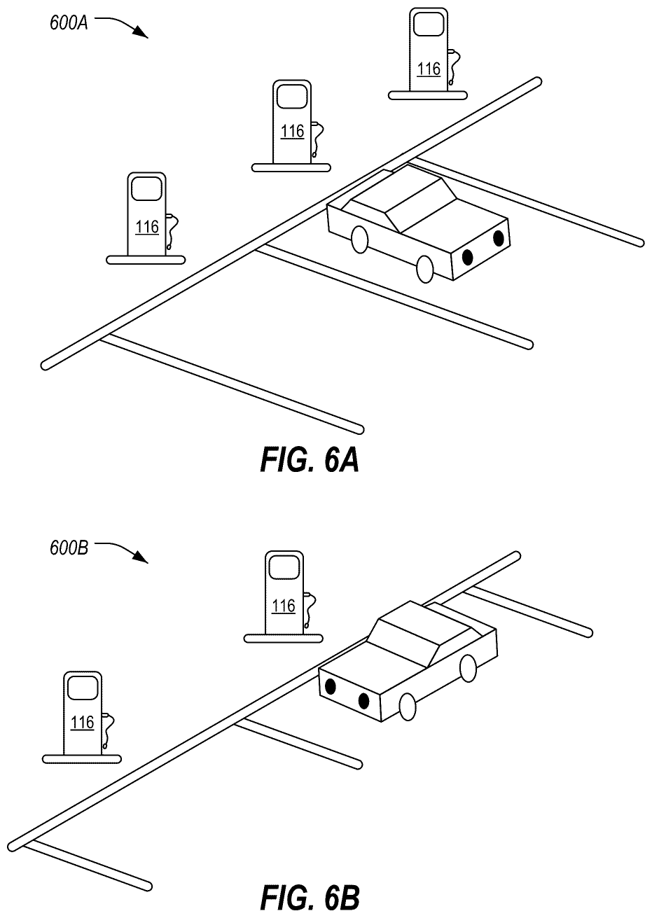

FIGS. 6A-6B collectively illustrate a specific example of perpendicular parking vs parallel parking the charging stations 116. FIG. 6A illustrates an example 600A of charging stations 116 with perpendicular parking (although other examples may use angled parking such as 30 degree or 45 degree parking), while FIG. 6B illustrates an example 600B of charging stations 116 with parallel parking spots.

EV truck drivers may find it especially relevant whether a parking spot can accommodate trailer parking. Similarly, EV van drivers may require information on whether the parking space is sufficiently large. By leveraging the camera sensors 108 of the vehicles 102 and utilizing calibrated photos, the multi-modal model 130 may be able to identify these factors.

Further, additional sensor 108 signals in the vehicle data 118, such as the trailer parking assist signal may be used to supplement the inputs to the multi-modal model 130. In an example, if an EV truck vehicle 102 has activated the trailer parking assist feature, when pulling into a charging station 116, it implies that the parking for that charging station 116 support a vehicle 102 in a towing configuration.

Similar to as discussed above with respect to rain roofs, inference of parking size, style, and height may be dependent on the image quality being used. If the multi-modal model 130 relies solely on customer photos, it may be difficult to determine the orientation of the photo. This can introduce significant uncertainty when applying image classification algorithms. However, by using the sensors 108 of the vehicles 102, a consistent known camera orientation and direction of movement may be input to the multi-modal model 130 when inferencing the parking size, style, and height. This may increase the accuracy of the results as compared to previous systems. For instance, for the charger monitoring server 122 may request data from the known camera sensor 108 of the vehicles 102 when performing the analysis of parking spot orientation.

As some further examples, Table 2 illustrates a mapping of features of charging stations 116 to potential sensors 108 from which vehicle data 118 may be requested in data requests 140 to update the respective feature:

TABLE 2
Mapping of Features to Vehicle Sensors

| Feature | Sensors |
|---|---|
| Snow clearance | Ambient Temperature |
| | Sensor + Rain Sensor |
| Night Illumination | Light Sensor |
| Cleanliness of surrounding | Camera Sensor |
| Designated outside seating | Camera Sensor |
| Visibility to main highway, to other users | Camera Sensor |
| Condition of pavement | Camera Sensor |

In some examples, the health status of infrastructure with respect to the charging stations 116 may be updated using the system 100. This may be done in addition to the updating of the charger feature table 132 descriptive of which charging stations 116 have which features. Table 3 illustrates some examples of features and sensor 108 that may be used to identify such infrastructure issues.

In an example, camera sensors 108 of the vehicle 102 may be used to identify cracks, potholes, or uneven surfaces in the pavement around the charging station 116. This may allow for the identification of and fixing of hazards for EV drivers and pedestrians, especially during ingress and egress from the charging station 116.

In another example, camera sensors 108 of the vehicle 102 may be used to detect damage to signage, including missing letters, faded colors, or physical damage due to vandalism or weather. Clear and visible signage is useful for guiding EV drivers to the charging station 116 and providing essential information about usage, rates, and other guidelines.

In yet another example, camera sensors 108 of the vehicle 102 may identify structural issues such as cracks, leaks, or sagging in rooftops or canopies covering the charging area. Issues with these structures may pose issues to users and may also affect the functionality of charging equipment if exposed to weather elements.

As yet a further example, light level sensors 108 and camera sensors 108 of the vehicle 102 may detect malfunctioning or inadequate lighting around the charging station 116, including streetlights, pathway lights, or signage illumination. Proper lighting is useful for ensuring user safety, especially during nighttime charging sessions.

In still another example, camera, radar, and/or ultrasound sensors 108 of the vehicle 102 may identify obstacles or barriers that may hinder accessibility to the charging station 116, such as uneven sidewalks, high curbs, or obstructed pathways. Ensuring accessibility for all users, including those with disabilities, is essential for promoting inclusivity and compliance with accessibility standards.

Also, camera, radar, and/or ultrasound sensors 108 of the vehicle 102 may be used to detect overgrown vegetation or foliage that may obstruct visibility, signage, or access pathways around the charging station 116. Regular maintenance of vegetation ensures clear sightlines and unobstructed access to the charging infrastructure.

In another example, camera sensors 108 of the vehicle 102 mat be used to detect environmental issues such as water puddles, ice patches, or debris accumulation around the charging station 116. These hazards can create slip and fall risks for users and may also damage equipment if left unaddressed.

Thus, the sensors 108 of the vehicle 102 may be used to detect environmental features of charging stations 116. Additionally, the disclosed approach may potentially offer another digital service to EV drivers by providing incentives for them to explore new and unpopular public charging locations.

The system 100 may be scaled to cover many or even all charging stations 116, potentially including restricted charging locations, such as company charging sites, commercial charging sites, and hotel charging sites. The disclosed approach also feature leverages cloud computing and generative AI technologies to enhance the capability and accuracy of feature detection.

The system 100 also does not require vehicles 102 to contain all the sensors 108, as the system 100 it includes an interface configured to communicate with a plurality of vehicles 102 some of which may have the required data. Furthermore, the disclosed approach has the flexibility to leverage any sensors 108 of the vehicle 102, whether built-in sensors 108 or plug-and-play sensors 108, such as dash cams.

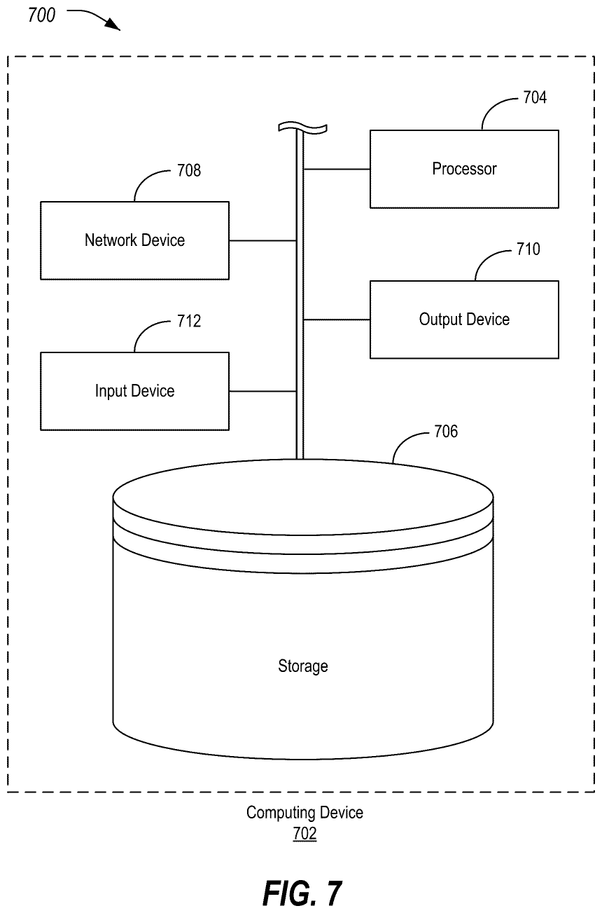

FIG. 7 illustrates an example computing device 702 for implementing machine-learned dynamic charging station 116 assessment for vehicles 102. Referring to FIG. 7, and with reference to FIGS. 1-6B, the vehicles 102, TCU 104, communications network 106, sensors 108, GNSS controller 110, HMI controller 112, charging controller 114, charging stations 116, mobile devices 120, charger monitoring server 122, and third-party data servers 128 are examples of such computing devices 702. Computing devices 702 generally include computer-executable instructions, such as those of the charger service 124 and charger application 134, where the instructions may be executable by one or more computing devices 702. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as the vehicle data 118, third-party data 126, multi-modal model 130, and charger feature table 132, may be stored and transmitted using a variety of computer-readable media.

As shown, the computing device 702 may include a processor 704 that is operatively connected to a storage 706, a network device 708, an output device 810, and an input device 712. It should be noted that this is merely an example, and computing devices 702 with more, fewer, or different components may be used.

The processor 704 may include one or more integrated circuits that implement the functionality of a central processing unit (CPU) and/or graphics processing unit (GPU). In some examples, the processors 704 are a system on a chip (SoC) that integrates the functionality of the CPU and GPU. The SoC may optionally include other components such as, for example, the storage 706 and the network device 708 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 704 executes stored program instructions that are retrieved from the storage 706. The stored program instructions, accordingly, include software that controls the operation of the processors 704 to perform the operations described herein. The storage 706 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to an output device 710. The output device 710 may include a graphical or visual display device, such as an electronic display screen, projector, printer, or any other suitable device that reproduces a graphical display. As another example, the output device 710 may include an audio device, such as a loudspeaker or headphone. As yet a further example, the output device 710 may include a tactile device, such as a mechanically raiseable device that may, in an example, be configured to display braille or another physical output that may be touched to provide information to a user.

The input device 712 may include any of various devices that enable the computing device 702 to receive control input from users. Examples of suitable input devices 712 that receive human interface inputs may include keyboards, mice, trackballs, touchscreens, microphones, graphics tablets, and the like.

The network devices 708 may each include any of various devices that enable the described components to send and/or receive data from external devices over networks. Examples of suitable network devices 708 include an Ethernet interface, a Wi-Fi transceiver, a cellular transceiver, or a BLUETOOTH or Bluetooth Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for using a multi-modal model to update a charger feature table comprising:
for each charging station indicated by a charger feature table descriptive of which charging stations have which of a plurality of features, and for each feature of the features of the charging station:
if a value of the feature is unknown or stale:
identifying vehicle data to capture according to the feature, the vehicle data being specified in terms of types of sensors of vehicles of known configurations;
broadcasting a data request to the vehicles indicating the vehicle data to be captured;
receiving new vehicle data from the vehicles responsive to the data request;
using the multi-modal model, trained to recognize the plurality of features using the types of sensors of the vehicles of known configurations, to determine an updated value for the feature based at least in part on the new vehicle data; and
updating the charger feature table to include the updated value for the feature;
and
using the charger feature table to identify charging stations for a requesting vehicle.

2. The method of claim 1, further comprising:
utilizing a mapping of features to the types of sensors to identify the new vehicle data being requested for capture for the feature as information captured from the indicated types of the sensors.

3. The method of claim 1, wherein a time-to-live is defined for each feature of the plurality of features and further comprising:
identifying the feature as stale based on the feature having been updated longer than the time-to-live.

4. The method of claim 1, wherein the vehicle data includes a plurality of data types, the plurality of data types including at least two of image data, textual data, and audio data.

5. The method of claim 1, wherein the multi-modal model further utilizes third-party data in combination with the vehicle data to recognize the features, the third-party data including one or more of: reviews of the charging stations, social media posts about the charging stations, and/or results of web searches or image searches relating to the charging stations and/or amenities surrounding the charging stations.

6. The method of claim 1, further comprising one or more of:
performing semantic segmentation to identify and classify objects in images or videos and to determine one or more of object boundaries, illumination levels, and/or weather conditions;
performing aspect-based sentiment analysis (ABSA) to determine a sentiment with respect to the feature of the charging station; and/or
performing retrieval augmented generation (RAG) to improve the updated value by relying on facts from various known-good data sources.

7. The method of claim 1, wherein the types of sensors includes at least two of image sensors, light level sensors, and/or moisture sensors.

8. A system for using a multi-modal model to update a charger feature table comprising:
a charger monitoring server comprising one or more hardware processors configured to, for each charging station indicated by a charger feature table descriptive of which charging stations have which of a plurality of features, and for each feature of the features of the charging station:
if a value of the feature is unknown or stale:
identify vehicle data to capture according to the feature, the vehicle data being specified in terms of types of sensors of vehicles of known configurations,
broadcast a data request to the vehicles indicating the vehicle data to be captured,
receive new vehicle data from the vehicles responsive to the data request,
use the multi-modal model, trained to recognize the plurality of features using the types of sensors of the vehicles of known configurations, to determine an updated value for the feature based at least in part on the new vehicle data, and
update the charger feature table to include the updated value for the feature;
and
use the charger feature table to identify charging stations for a requesting vehicle.

9. The system of claim 8, wherein the charger monitoring server is further configured to:
utilize a mapping of features to the types of sensors to identify the new vehicle data being requested for capture for the feature as information captured from the indicated types of the sensors.

10. The system of claim 8, wherein a time-to-live is defined for each feature of the plurality of features and wherein the charger monitoring server is further configured to:
identify the feature as stale based on the feature having been updated longer than the time-to-live.

11. The system of claim 8, wherein the vehicle data includes a plurality of data types, the plurality of data types including at least two of image data, textual data, and audio data.

12. The system of claim 8, wherein the multi-modal model further utilizes third-party data in combination with the vehicle data to recognize the features, the third-party data including one or more of: reviews of the charging stations, social media posts about the charging stations, and/or results of web searches or image searches relating to the charging stations and/or amenities surrounding the charging stations.

13. The system of claim 8, wherein the charger monitoring server is further configured to one or more of:
perform semantic segmentation to identify and classify objects in images or videos and to determine object boundaries, illumination levels, and/or weather conditions;
perform aspect-based sentiment analysis (ABSA) to determine a sentiment with respect to the feature of the charging station; and/or
perform retrieval augmented generation (RAG) to improve the updated value by relying on facts from various known-good data sources.

14. The system of claim 8, wherein the types of sensors includes at least two of image sensors, light level sensors, and/or moisture sensors.

15. A non-transitory computer-readable medium comprising instructions for using a multi-modal model to update a charger feature table descriptive of which charging stations have which of a plurality of features that, when executed by one or more hardware processors of a charger monitoring server, cause the charger monitoring server to perform operations including to:
for each charging station indicated by the charger feature table, and for each feature of the features of the charging station:
if a value of the feature is unknown or stale:
identify vehicle data to capture according to the feature, the vehicle data being specified in terms of types of sensors of vehicles of known configurations;
broadcast a data request to the vehicles indicating the vehicle data to be captured;
receive new vehicle data from the vehicles responsive to the data request;
use the multi-modal model, trained to recognize the plurality of features using the types of sensors of the vehicles of known configurations, to determine an updated value for the feature based at least in part on the new vehicle data; and
update the charger feature table to include the updated value for the feature; and
use the charger feature table to identify charging stations for a requesting vehicle.

16. The non-transitory computer-readable medium of claim 15, further comprising instructions that, when executed by the one or more hardware processors of the charger monitoring server, cause the charger monitoring server to perform operations including to:
utilize a mapping of features to the types of sensors to identify the new vehicle data being requested for capture for the feature as information captured from the indicated types of the sensors, wherein the types of sensors includes at least two of image sensors, light level sensors, and/or moisture sensors.

17. The non-transitory computer-readable medium of claim 15, wherein a time-to-live is defined for each feature of the plurality of features and further comprising instructions that, when executed by the one or more hardware processors of the charger monitoring server, cause the charger monitoring server to perform operations including to:
identify the feature as stale based on the feature having been updated longer than the time-to-live.

18. The non-transitory computer-readable medium of claim 15, wherein the vehicle data includes a plurality of data types, the plurality of data types including at least two of image data, textual data, and audio data.

19. The non-transitory computer-readable medium of claim 15, wherein the multi-modal model further utilizes third-party data in combination with the vehicle data to recognize the features, the third-party data including one or more of: reviews of the charging stations, social media posts about the charging stations, and/or results of web searches or image searches relating to the charging stations and/or amenities surrounding the charging stations.

20. The non-transitory computer-readable medium of claim 15, further comprising instructions that, when executed by the one or more hardware processors of the charger monitoring server, cause the charger monitoring server to perform operations including to one or more of:
perform semantic segmentation to identify and classify objects in images or videos and to determine object boundaries, illumination levels, and/or weather conditions;
perform aspect-based sentiment analysis (ABSA) to determine a sentiment with respect to the feature of the charging station; and/or
perform retrieval augmented generation (RAG) to improve the updated value by relying on facts from various known-good data sources.
